(19) United States
(12) Patent Application Publication
(10) Pub. No.: US 2025/0179743 A1
(43) Pub. Date: Jun. 5, 2025

(54) NOISE BARRIER WALL

(71) Applicant: Fraunhofer-Gesellschaft zur Förderung der angewandten Forschung e.V., Munich (DE)

(72) Inventors: Felix BASLER, Freiburg (DE); Jonas HUYENG, Freiburg (DE)

(73) Assignee: Fraunhofer-Gesellschaft zur Förderung der angewandten Forschung e.V., Munich (DE)

(21) Appl. No.: 19/040,278

(22) Filed: Jan. 29, 2025

Related U.S. Application Data
(63) Continuation of application No. PCT/EP2023/071229, filed on Aug. 1, 2023.

(30) Foreign Application Priority Data
Aug. 2, 2022 (DE) 10 2022 207 970.1

(51) Int. Cl. E01F 8/00; H02S 20/21

(52) U.S. Cl. CPC E01F 8/0017; E01F 8/0023; H02S 20/21

(57) ABSTRACT

A noise barrier wall is provided for combined sound absorption and solar power generation, comprising a plate-like main body, a large number of solar cells encapsulated in the main body, at least one absorber cartridge arranged on at least one side of the main body and filled with sound-absorbing material, and devices for fastening the main body and the absorber cartridge to one another, the main body having, on one side, a light-permeable surface section which permits light that falls on the one side of the main body to pass through to at least some of the solar cells, the absorber cartridge being arranged adjacent to the light-permeable surface section in such a way that it is in contact with the main body and covers a further surface section of the main body, this further surface section lying in the same plane as the light-permeable surface section.

### CROSS-REFERENCE TO RELATED APPLICATIONS

This application is a continuation of PCT/EP2023/071229 filed Aug. 1, 2023, the entire contents of which are hereby incorporated by reference, and which claims priority under 35 USC § 119 to German patent application 2022 207 970.1 filed Aug. 2, 2022.

### TECHNICAL FIELD

The invention relates to a noise barrier wall comprising a plate-like main body which is provided with sound-absorbing material. Noise barrier walls of this type are used, for example, along traffic routes to reduce the noise emissions into the surrounding area.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 shows a top view of a main body, formed by a PV module, of the noise barrier wall according to the invention in a schematic representation;

FIGS. 2a to 2d show schematic cross-sections of different forms of absorber cartridges in connection with the areas projected onto the main body;

FIGS. 3a and 3b show schematic cross-sections of absorber cartridges with different folds;

FIG. 4 shows a top view of an absorber cartridge with parts of a frame for clamping the absorber cartridge in a schematic representation; and

FIGS. 5a and 5b are schematic cross-sections of PV modules with different occupancy of solar cells.

### DETAILED DESCRIPTION

Conventional photovoltaic modules, abbreviated as “PV modules”, use a glass plate as the outermost layer in order to protect the photoactive components which are encapsulated in polymer films and are usually referred to as “solar cells”. In connection with noise barrier walls where a significant portion of the energy of incident sound waves shall be absorbed, it is normally not possible to use, on a large-scale, glass having the thickness normally used for PV modules since this glass is in a sense sound-hard and the energy is therefore reflected instead of absorbed.

For noise barrier walls, porous sound-absorbing materials (or “absorbers” for short) are often used in which the sound waves are scattered and lose energy in this process. These absorbers are usually enclosed by metallic cartridges, so-called “absorber cartridges”, and thus mechanically stabilized. However, a conventional PV module cannot be integrated in front of the absorber cartridges without eliminating the sound-absorbing effect of the absorber.

Some known noise barrier walls use conventional PV modules and integrate them into conventional noise barrier walls, the integration of the PV modules being done by mechanical connection. This connection can be carried out, for example, by plug-in, adhering or screwing. Due to the integration of conventional PV modules in conventional noise barrier walls, however, the sound-absorbing effect thereof is significantly reduced.

In some other known noise barrier walls, adapted PV modules are mounted on adapted absorber cartridges. The absorber cartridge here has a triangular cross-section, where one side is vertical, one side is aligned upwards and the other side is aligned downwards. The PV modules are placed on the side of the absorber cartridge that is aligned upwards. In this case, the PV module is located in front of the absorber cartridge, and the absorber cartridge forms the main body of the noise barrier wall, which is often, but not always, aligned vertically.

In another known noise barrier wall, no PV modules are used, but transparent materials such as glass or acrylic glass, in order to allow the wall to be transparent or translucent. Since these materials are also sound-hard in the thicknesses required for safety reasons, the enclosure of the transparent panes, which for the most part represent a non-absorbent area, is made from a frame which also has the characteristics of an absorber cartridge in order to achieve a sound-absorbing effect. In this case, the frame encloses the non-absorbing area and is only found in the perimeter of the non-absorbing area. However, this noise barrier wall does not have any photoactive properties.

In view of this, the object of the invention is to design a noise barrier wall of the type in question for combined sound absorption and solar power generation in such a way that its production is simpler and more cost-effective than before and, at the same time, that greater mechanical stability and better sound absorption than before are achieved.

According to the invention, a noise barrier wall for the combined sound absorption and solar power generation is proposed. It has a plate-like main body. A large number of solar cells is encapsulated in this main body. In addition, the main body carries, on at least one side, at least one absorber cartridge which is filled with sound-absorbing material.

Furthermore, the noise barrier wall includes devices for connecting the main body and the absorber cartridge to one another. The main body has at least one light-permeable surface section. It is designed in such a way that light incident on at least one side of the main body can reach at least some of the encapsulated solar cells.

The object of the invention is achieved by arranging the absorber cartridge adjacent to the light-permeable surface section in such a way that it is in contact with the main body and by covering a further surface section of the main body, which lies in the same plane as the light-permeable surface section.

In contrast to known noise barrier walls, in which absorber cartridges and PV modules are combined, the PV module of the noise barrier wall according to the invention forms the main body of the wall and the absorber cartridge is placed in front of the PV module. Therefore, the noise barrier wall according to the invention renders possible a quick and uncomplicated installation while providing at the same time high mechanical stability, high sound absorption and durability. Due to the modular design, the noise barrier wall can be adapted to the location.

According to the invention, the main body or the PV module differs from conventional PV modules in two aspects: on the one hand, additional photo-inactive areas are intentionally left on the module area during the occupancy thereof. On the other hand, the PV module is additionally combined with sound-absorbing elements so that, when used in a noise barrier wall, an increased sound-absorbing effect of the product is implemented.

In some embodiments of the invention, at least two absorber cartridges arranged at a lateral distance from one another are arranged adjacent to the light-permeable surface in such a way that they are in contact with the main body and cover in each case a respective surface section of the main body, the surface sections covered by the absorber cartridges lying in the same plane as the light-permeable surface section which is located between two adjacent absorber cartridges.

The noise barrier wall according to the invention is highly scalable, reliable and more cost-effective than known noise barrier walls for the combined sound absorption and solar power generation.

In some embodiments of the invention, more than two absorber cartridges which are laterally spaced apart from one another are arranged in such a way that they are in contact with the main body, each absorber cartridge covering a respective surface section of the main body and a plurality of light-permeable surface sections being provided, which lie in the same plane as the surface sections covered by the absorber cartridges, one of the light-permeable surface sections being located between two adjacent absorber cartridges in each case.

In some embodiments of the invention, the main body has one or two opposing lateral edge sections and a light-permeable lateral surface section is arranged between the or each lateral edge and the adjacent absorber cartridge, and the or each lateral light-permeable surface section is adjacent to a surface section covered by an absorber cartridge, the lateral light-permeable surface section or sections lying in the same plane as the surface section or sections of the main body that are covered by the absorber cartridge or cartridges.

In some embodiments of the invention, the assembly of the noise barrier wall according to the invention is simplified in particular by the fact that the or each absorber cartridge is attached to the main body by adhering and/or clamping.

With regard to the clamping attachment, it is advantageous for the main body to be surrounded by a frame that clamps the or each absorber cartridge to the main body. This frame is a preferred device for fastening the main body and absorber cartridge to one another.

In order to make better use of the incidence of light on the noise barrier wall for the solar power generation and, at the same time, achieve better noise protection than before, it is advantageous for the or each absorber cartridge to be rectangular, triangular, hexagonal or trapezoidal in cross-section. For this purpose, it is also advantageous for the or each absorber cartridge to have an internal or external fold at its base facing the main body, which fold is in abutment with the main body.

In some embodiments of the invention, the main body can have two light-permeable layers, one layer of which includes the surface of the main body on one side thereof and the other layer of which includes the surface of the main body on the opposite side thereof, and a layer of solar cells is encapsulated between the two layers, each solar cell of a first subset of solar cells being photoactive on both sides and being arranged in each case in a first region of the main body, which in each case is located laterally next to the or each covered surface section, and each solar cell of a second subset of solar cells being photoactive on one side and being arranged in each case in a second region of the main body, which is covered by the or each absorber cartridge.

Alternatively, the main body has two light-permeable layers, one layer of which includes the surface of the main body on one side thereof and the other layer of which includes the surface of the main body on the opposite side thereof, and two layers of solar cells are encapsulated between the two layers, each solar cell of the one layer of solar cells being photoactive on one or both sides and being arranged in each case in a first region of the main body, which is located in each case laterally next to the or each covered surface section, and each solar cell of the other layer of solar cells being photoactive on one or both sides and in each case being arranged in a second region of the main body, which is located between the one layer of solar cells and the other light-permeable layer.

The noise barrier wall according to the invention is highly scalable. In some embodiments of the invention, the noise barrier wall can therefore be extended by connecting it to at least one further noise barrier wall of identical design. However, the noise barrier wall can also be part of a plurality of identical noise barrier walls connected to one another.

In use, the noise barrier wall is preferably aligned vertically, the absorber cartridges also extending vertically lengthwise and being arranged parallel to one another. A vertical alignment of the noise barrier wall can be understood to mean a slight inclination in the range of about ±15° or ±10° or ±8° from the vertical.

Exemplary embodiments of the invention use an adapted PV module layout on the basis of conventional materials and manufacturing processes and combine it with a suitable design of the absorber cartridges in order to combine photoactive and sound-absorbing areas in a single component. In this connection, the two sub-elements are combined by a frame system that establishes a permanent connection between the two sub-elements, in particular by clamping, but alternatively also by means of adhesion or another connection technique. In the simplest case, the frame system is also based on conventional frame systems for PV modules but can also be additionally and easily adapted to this application.

In the case of exemplary embodiments of the invention, the front side facing the noise source is divided into different sections. There are photoactive areas, e.g. realized by encapsulated solar cells, sound-absorbing areas, e.g. realized by metallic absorber cartridges that have a perforated metal jacket and are filled with sound-absorbing materials, and additional photoinactive regions, e.g. for the mechanical connection of the different sub-elements.

In contrast to the conventional module, additional edge conditions are implemented when designing the module layout, instead of maximizing the photoactive area as usual. This is described in more detail below:

The individual sub-elements are designed in such a way that they affect the functionality of the other sub-elements as little as possible. Therefore, the PV module layout is designed in such a way that there are intentionally photo-inactive areas above which the other sub-elements are installed. This adaptation is decisive for the end product since incorrectly designed occupancies can lead to systematic shading during operation, which on the one hand reduces the yield, and on the other hand also poses a safety risk, since shaded regions are additionally stressed.

Similarly, the absorber cartridges are designed in such a way that they allow the highest possible sound absorption. This can be achieved in particular by means of cantilevered shapes, e.g. in the form of triangles or trapezoids, which achieve a higher sound effect due to edge effects. The height and width of the shapes are here adapted in such a way that the visual effect (in particular shading) and the acoustic effect are as well coordinated as possible.

A projected area that is substantially given by the supporting area can be assigned to the absorber cartridges. This area is shaded when the incidence of light is vertical. Therefore, at least this area should be provided to be inactive in the module layout.

For the mechanical attachment of the absorber cartridges to the main body, it is essential that the absorber cartridges are designed in such a way that sufficient supporting areas are available. This can be realized, for example, by additional lips or folds, which are circumferential or also locally shaped. These folds can be designed to face outwards or inwards.

In addition to shading in the case of vertical incidence of light, shading due to oblique incidence is also taken into account. Here, it depends on the angles at which light can still be captured, which is mainly defined by the application. In the case of beveled absorber cartridges, the angle of the inclination must be compared with the desired angle of incidence in order to determine the projected area.

The PV module can then be manufactured by means of conventional production processes, it being possible to use e.g. the conventional glass pane as the outermost layer.

The absorber cartridges can be made by means of conventional production processes and e.g. be filled with conventional sound-absorbing materials. In this case, it is recommended to select materials with the highest possible absorption in order to achieve the highest possible overall sound absorption. However, less highly absorbing materials can also be used if the overall product ultimately achieves the sound absorption values set in the usual approval procedures.

This optimization can be carried out experimentally or by simulation. In this connection, the proportions of photoinactive area or the projected area of the absorber cartridges can also be included in the optimization, so that the sub-elements are coordinated with one another.

For the combination of the sub-elements, the filled absorber cartridges can be placed on the glass pane, and in so doing they are aligned in such a way that no photoactive surfaces are covered in a perpendicular top view.

In order to enclose in a clamping fashion the PV module and the absorber cartridges resting thereon, a conventional PV module frame can be used which surrounds the external folds of the absorber cartridges. As a result, it is possible to realize a stable mechanical connection of the absorber cartridges to the main body.

Alternatively, the folds can also be used to fix the cartridges to the glass by means of suitable adhesives. In this case, the folds can also be formed inwards, below the projected area of the absorber cartridge, which means that less non-photoactive area is required in the module layout. In the case of external folds, a combination with mechanical clamping is still possible. Of course, internal and external folds can also be combined.

In addition, other techniques can be used to connect the enclosing frame and the absorber cartridge, such as welding or soldering or brazing. To this end, the shape of the frame can also be adapted in order to improve the stability of the product or to simplify the manufacturing process. Furthermore, the frame can be adapted to the installation situation in a noise barrier wall. In these cases, the frame differs more from conventional frames for conventional PV modules.

For certain situations, it may be desirable to occupy the module with solar cells in the photo-inactive regions as well. This is above all advantageous if light shall also be absorbed from the second side, which does not face the noise source.

Nevertheless, damage to the solar cells on the side facing the noise source must be prevented. For this purpose, these solar cells must either be connected in an independent series connection. Alternatively, a second layer of solar cells can be integrated into the module.

In the former case, the photoactive areas next to the cartridges can be equipped with bifacial solar cells, for example. In the latter case, this is irrelevant since they are shaded by the second layer.

In summary, the noise barrier wall according to the invention has the following effects and advantages:

The matching of the absorber cartridges and the PV module layout creates a combined PV module that renders possible sound absorption and electrical energy generation in a single element.

The falling back on established manufacturing methods renders possible a high level of product reliability and rapid implementation in existing manufacturing capacities.

Due to its combined functionality, the element requires less base area than alternative cantilevered designs, in which the sound-hard glass side of the PV module faces away from the street.

The preferred clamping of the sub-elements adapted for this purpose renders possible a quick and uncomplicated assembly and, at the same time, provides high mechanical stability and durability.

Since the PV module shows the base area of the element, it is possible to create a high degree of mechanical stability through the glass pane and to provide a high level of protection for the encapsulated solar cells. In addition, the production follows established processes and is therefore highly scalable, reliable and more cost-effective than alternative designs.

A high level of sound absorption can be achieved by the clever design of the absorber cartridges and suitable sound-absorbing materials. In this connection, the sound effect will be greater than if the projected area were equipped with a flat absorber.

The enclosed drawings of exemplary embodiments according to the invention will be used below to describe the invention in more detail.

In the drawings, the components of the invention are described uniformly by means of the following reference signs:
1 main body
2 photo-inactive surface section
3 photoactive surface section
4a, 4b, 4c solar cells
5 module frame
5a upper section
5b lower section
6 absorber cartridge
7 front side
8 supporting area
9 projected area
10 internal fold
11 external fold
11a upper fold section
11b lower fold section
12 front protective layer
13 rear protective layer

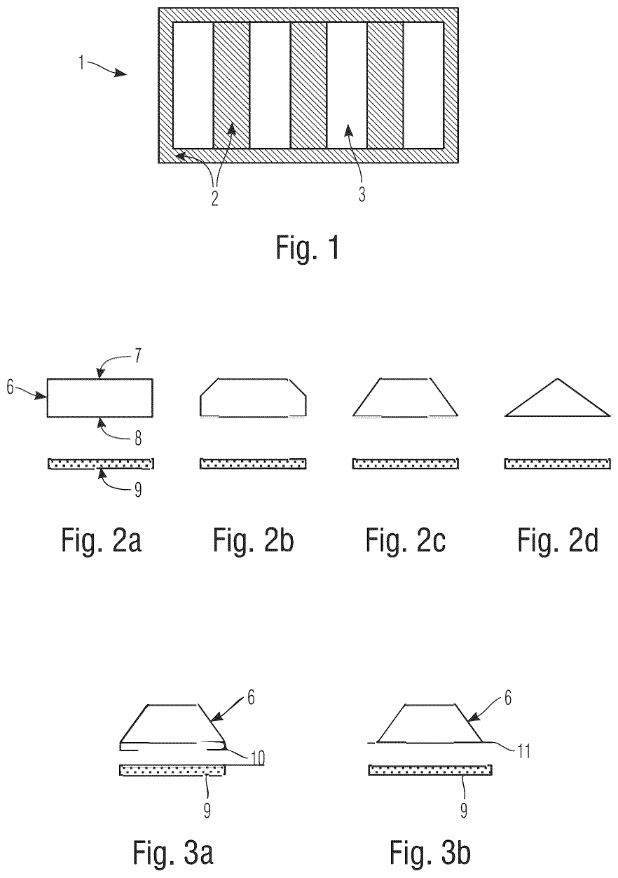

As can be seen from the drawings, a noise barrier wall according to the invention has a plate-like main body 1, which is formed by a photovoltaic module (“PV module”). FIG. 1 shows a schematic top view of the side (front side) of the main body 1 that faces a noise source (not shown). In the illustrated example, the main body 1 has a rectangular shape. The flat surface of the main body is divided into photoinactive surface sections 2, which are hatched in FIG. 1, and photoactive surface sections 3, which are shown in FIG. 1 as white, unhatched fields. The photoactive surface sections 3 are surface sections under which a plurality of electrically interconnected solar cells 4a are embedded in the main body 1, it being possible for the solar cells 4a to be monofacial or bifacial solar cells. In the case of monofacial solar cells 4a, the solar cells 4a only react to the light falling through the photoactive surface sections 3 by generating electrical energy. The use of bifacial solar cells is described in more detail below in connection with the description of FIGS. 5a and 5b. The photo-inactive surface sections 2, on the other hand, are the surface sections which are covered and thus shaded by parts attached to the main body 1, such as module frames 5 and absorber cartridges 6, so that no light can pass through the photo-inactive surface sections 2 and into the interior of the main body 1. The photoinactive surface section 2 circumferential along the edge of the main body 1 in FIG. 1 is covered by the module frame 5 and the three strip-like parallel photoinactive surface sections 2, which are located in FIG. 1 within the surface section 2 that is covered by the module frame 5 and circumferential along the edge of the main body 1, are covered by the absorber cartridges 6, the number of absorber cartridges 6 and thus the photoinactive surface sections 2 covered by them can, of course, be larger or smaller than shown in FIG. 1. The number of absorber cartridges 6 and the arrangement thereof on the main body 1 determine the shape and number of the photoactive surface sections 3 of the main body 1. Therefore, it is of course also possible to provide more or fewer photoactive surface sections 3 and other shapes of photoactive surface sections 3 than shown in FIG. 1.

Possible cross-sectional shapes of the absorber cartridges 6 are shown schematically in FIGS. 2a to 2d with the areas 9, which are depicted in each case below these cross-sectional shapes and are projected from the absorber cartridges 6 onto the surface of the main body 1, FIG. 2a illustrating a rectangular cross-sectional shape, FIG. 2b showing a hexagonal one, FIG. 2c depicting a trapezoidal and FIG. 2d a triangular cross-sectional shape of the absorber cartridges 6. Using the example of the rectangular cross-sectional shape of an absorber cartridge 6, which is shown in FIG. 2a, the position of the front side 7 of the absorber cartridge 5 and the position of the supporting area 8 thereof on the main body 1 is shown in the assembled state of the noise barrier wall. The absorber cartridges 6 are made of metal, perforated aluminum sheeting being preferably used for the outer wall and porous absorber materials being used for the filling of the cartridges 6.

FIGS. 3a and 3b show two variants of folds 10, 11 in cross-section on the basis of absorber cartridges 6 with a trapezoidal cross-section, by means of which the absorber cartridges 6 are mechanically attached to the main body 1, FIG. 3a showing an absorber cartridge 6 having an internal fold 10 and FIG. 3b showing an absorber cartridge 6 having an external fold 11. In addition, FIGS. 3a and 3b show the supporting areas 9 projected from the absorber cartridges 6 on the main body 1, it being clear that, in the case of the absorber cartridge 6 with the external fold 11, the projected area 9 is larger than the projected area 9 in the case of the absorber cartridge 6 having the internal fold 10.

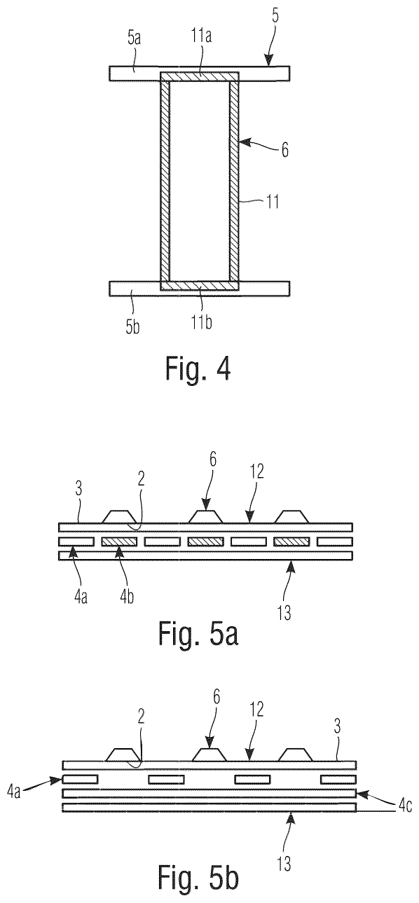

As shown in FIG. 4, an absorber cartridge 6 that has a circumferential external fold 11 can be clamped to the module frame 5 at its upper and lower ends in FIG. 4 because in the illustrated example the upper section 11a of the external fold 11 and an upper section 5a of the module frame 5 overlap and the lower section 11b of the external fold 11 and a lower section 5b of the module frame 5 overlap. The fold sections 11a, 11b of the external fold 11 that overlap with the module frame 5 are shown in hatched fashion in FIG. 4. The clamping of the external fold 11 and the module frame 5 ensures a stable mechanical connection of the absorber cartridge 6 to the main body 1 enclosed by the module frame 5.

FIGS. 5a and 5b schematically show two different types of arrangement of solar cells 4a, 4b, 4c in the main body 1, these types of arrangement of solar cells 4a, 4b, 4c being advantageous if light also falls on the noise barrier wall on the side facing away from the noise source as well and can be used to generate solar power.

FIG. 5a schematically shows a cross-section of a part of a noise barrier wall, the absorber cartridges 6 being arranged on the front side of the main body 1 facing the noise source, and the front side being formed by a front protective layer 12, which can consist of a glass pane, for example. On the rear side of the main body 1 there is a rear protective layer 13, which can also consist of a glass pane. Between the two protective layers 12, 13 there is a layer of solar cells 4a, 4b which are arranged side by side. The solar cells 4a thereof which are shown in an unhatched fashion are bifacial solar cells and are each arranged in such a way that they are laterally offset to the absorber cartridges 6, so that light can fall on them through both the front protective layer 12 and the rear protective layer 13, and they can convert this light, which falls thereon from both sides, into electrical energy. In FIG. 5a, the hatched solar cells 4b are arranged directly under the absorber cartridges 6. They are photoactive on one side and are therefore oriented in such a way that they can receive light falling through the rear protective layer 13 and convert it into electrical energy. In the arrangement of solar cells 4a, 4b that are shown in FIG. 5a, neighboring solar cells are not connected to one another.

The arrangement of solar cells 4a, 4c, which is shown in FIG. 5b, differs from the arrangement shown in FIG. 5a in that the solar cells 4a, 4c are arranged in two layers arranged one above the other between the front protective layer 12 and the rear protective layer 13, the solar cells 4a of the upper layer in FIG. 5b being arranged in each case in such a way that they are laterally offset to the absorber cartridges 6 and therefore receive the light falling through the front protective layer 12 and convert it into electrical energy. The solar cells 4c of the lower layer are aligned in such a way that they receive the light falling through the rear protective layer 13 and convert it into electrical energy. The solar cells 4a, 4c in FIG. 5b can be single-sided (monofacial) or double-sided (bifacial) photoactive solar cells. If they are only photoactive on one side, i.e. they are monofacial, their orientation must be such that they can react to the incidence of light from either the front or to the incidence of light from the back by generating electrical energy.

Of course, the invention is not limited to the illustrated embodiments. Therefore, the above description should not be regarded as limiting but as explanatory. The following claims should be understood in such a way that an indicated feature is present in at least one embodiment of the invention. This does not exclude the presence of further features. Insofar as the claims and the above description define “first” and “second” embodiments, this designation is used to distinguish between two similar embodiments without establishing an order of priority.

To clarify the use of and to hereby provide notice to the public, the phrases “at least one of <A>, <B>, . . . and <N>” or “at least one of <A>, <B>, . . . or <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

1. A noise barrier wall for combined sound absorption and solar power generation, comprising a plate-like main body, a large number of solar cells encapsulated in the main body, at least one absorber cartridge arranged on at least one side of the main body and filled with sound-absorbing material, and devices for fastening the main body and the absorber cartridge to one another, the main body having, on one side, a light-permeable surface section which permits light that is incident on the one side of the main body to pass through to at least some of the solar cells, wherein the absorber cartridge is arranged adjacent to the light-permeable surface section in such a way that it is in contact with the main body and covers a further surface section of the main body, this further surface section lying in the same plane as the light-permeable surface section.

2. The noise barrier wall of claim 1, wherein at least two absorber cartridges arranged at a lateral distance from one another are arranged adjacent to the light-permeable surface section in such a way that they are in contact with the main body, and cover in each case a respective surface section of the main body, the surface sections covered by the absorber cartridges lying in the same plane as the light-permeable surface section which is located between two adjacent absorber cartridges.

3. The noise barrier wall of claim 1, wherein more than two absorber cartridges that are laterally spaced apart from one another are arranged in such a way that they are in contact with the main body, each absorber cartridge covers a respective surface section of the main body and a plurality of light-permeable surface sections are provided, which lie in the same plane as the surface sections (2) covered by the absorber cartridges, one of the light-permeable surface sections being located between two adjacent absorber cartridges in each case.

4. The noise barrier wall of claim 1, wherein the main body has one or two opposite lateral edge sections and a light-permeable lateral surface section is arranged between the or each lateral edge and the adjacent absorber cartridge, and the or each lateral light-permeable surface section is adjacent to a surface section covered by an absorber cartridge, the lateral light-permeable surface section or sections lying in the same plane as the surface section or sections of the main body that is and/or are covered by the absorber cartridge or cartridges.

5. The noise barrier wall of claim 1, wherein the or each absorber cartridge is attached to the main body by adhering and/or clamping.

6. The noise barrier wall of claim 1, wherein the main body is surrounded by a frame which clamps the or each absorber cartridge to the main body.

7. The noise barrier wall of claim 1, wherein the or each absorber cartridge is rectangular, triangular, hexagonal or trapezoidal in cross section.

8. The noise barrier wall of claim 1, wherein the or each absorber cartridge has, at its base facing the main body, an internal or external fold which is in abutment with the main body.

9. The noise barrier wall of claim 1, wherein the main body comprises two light-permeable layers, one layer of which includes the surface of the main body on one side thereof and the other layer of which includes the surface of the main body on the opposite side thereof, and a layer of solar cells is encapsulated between the two layers, each solar cell of a first subset of solar cells being photoactive on both sides and being arranged in each case in a first region of the main body which in each case lies laterally adjacent to the or each covered surface section, and each solar cell of a second subset of solar cells being photoactive on one side and being arranged in each case in a second region of the main body, which is covered by the or each absorber cartridge.

10. The noise barrier wall of claim 1, wherein the main body has two light-permeable layers, one layer of which includes the surface of the main body on one side thereof and the other layer of which includes the surface of the main body on the opposite side thereof, and two layers of solar cells are encapsulated between the two layers, each solar cell of the one layer of solar cells being photoactive on one or both sides and being arranged in each case in a first region of the main body, which in each case is located laterally next to the or each covered surface section, and each solar cell of the other layer of solar cells being photoactive on one or both sides and being arranged in each case in a second region of the main body, which lies between the one layer of solar cells and the other light-permeable layer.

11. The noise barrier wall of claim 1, wherein the noise barrier wall is extendable by connecting it to at least one further noise barrier wall configured according to claim 1.

12. A plurality of interconnected noise barrier walls, wherein each of the noise barrier walls is configured according to claim 1.
